(19) United States
(12) Patent Application Publication
(10) Pub. No.: US 2003/0191619 A1
(43) Pub. Date: Oct. 9, 2003

(54) Method and apparatus for implementing noise immunity and minimizing delay of CMOS logic circuits

(75) Inventors: Andrew Douglas Davies, Rochester, MN (US); Daniel Lawrence Stasiak, Austin, TX (US)

Correspondence Address: Robert R. Williams, IBM Corporation - Dept. 917, 3605 Highway 52 North, Rochester, MN, 55901, US

(73) Assignee: INTERNATIONAL BUSINESS MACHINES CORPORATION, ARMONK, NY (US)

(21) Appl. No.: 10/116,245

(22) Filed: Apr. 4, 2002

(51) Int. Cl. G06F 17/50

(52) U.S. Cl. 703/14

(57) ABSTRACT

A method and apparatus are provided for implementing dynamic noise immunity and minimizing delay of complementary metal oxide semiconductor (CMOS) logic circuits. A method of logical effort is applied to the CMOS logic circuits. Selected circuits within the CMOS logic circuits are checked for noise immunity utilizing a noise test simulation to identify each selected circuit failing the noise test simulation. An electrical effort is fixed to a value for providing noise immunity for each identified selected circuit failing the noise test simulation. The method of logical effort is applied to each remaining selected circuit not failing the noise test simulation. The sequential steps are repeated for each remaining selected circuit not failing the noise test simulation until no selected circuit failing the noise test simulation is identified. The selected circuits that are checked for noise immunity include, for example, dynamic circuits and passgate circuits. When none of the selected circuits fail the noise test simulation, or the electrical efforts have been fixed for all of the selected circuits failing the noise test simulation, the delay through the CMOS logic circuits has been minimized and the selected circuits are all assured of adequate noise immunity.

### FIELD OF THE INVENTION

The present invention relates generally to the data processing field, and more particularly, relates to a method and apparatus for implementing dynamic noise immunity and minimizing delay of complementary metal oxide semiconductor (CMOS) logic circuits.

### DESCRIPTION OF THE RELATED ART

The method of logical effort is a recent addition to the field of designing CMOS logic circuits that provides a way to minimize the delay of a CMOS circuits using the simple concepts of logical effort, electrical effort, and effort delay. The method of logical effort specifies a method of choosing the sizes of the transistors in these circuits such that the delay from the input to the output of the circuit is minimized. This method therefore has a wide application to CMOS design, and is easily implemented in software.

The method of logical effort is described in the book entitled “Logical Effort: Designing Fast CMOS Circuits” by Ivan Sutherland, Bob Sproull and David Harris, copyright 1999 by Academic Press. The method has a serious drawback when the circuits include dynamic circuits and other circuits that are susceptible to noise problems.

Dynamic circuits are susceptible to noise problems that can cause catastrophic system failure. Special attention must be given to the sizing of the transistors in dynamic circuits to make them immune to noise. The method of logical effort does not provide any attention to or does not address dynamic noise immunity. In fact, the method of logical effort can generate dynamic circuits that are guaranteed to fail, causing total system failure.

### SUMMARY OF THE INVENTION

A principal object of the present invention is to provide a method and apparatus for implementing dynamic noise immunity and minimizing delay of complementary metal oxide semiconductor (CMOS) logic circuits. Other important objects of the present invention are to provide such method and apparatus for implementing dynamic noise immunity and minimizing delay of complementary metal oxide semiconductor (CMOS) logic circuits substantially without negative effect and that overcome many of the disadvantages of prior art arrangements.

In brief, a method and apparatus are provided for implementing dynamic noise immunity and minimizing delay of complementary metal oxide semiconductor (CMOS) logic circuits. A method of logical effort is applied to the CMOS logic circuits. Selected circuits within the CMOS logic circuits are checked for noise immunity utilizing a noise test simulation to identify each selected circuit failing the noise test simulation. Each identified selected circuit failing the noise test simulation is fixed to provide acceptable noise immunity.

In accordance with features of the invention, an electrical effort is fixed to a value for providing noise immunity for each identified selected circuit failing the noise test simulation. The method of logical effort is applied to each remaining selected circuit not failing the noise test simulation. The sequential steps are repeated for each remaining selected circuit not failing the noise test simulation until no selected circuit failing the noise test simulation is identified. The selected circuits that are checked for noise immunity include, for example, dynamic circuits and passgate circuits. When none of the selected circuits fail the noise test simulation, or the electrical efforts have been fixed for all of the selected circuits failing the noise test simulation, the delay through the CMOS logic circuits has been minimized and the selected circuits are all assured of adequate noise immunity.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram representation illustrating a computer system for implementing dynamic noise immunity and minimizing delay of complementary metal oxide semiconductor (CMOS) logic circuits in accordance with the preferred embodiment;

FIGS. 2 and 3 are flow charts illustrating exemplary sequential steps for implementing dynamic noise immunity and minimizing delay of complementary metal oxide semiconductor (CMOS) logic circuits in accordance with the preferred embodiment;

FIG. 4 is a schematic and block diagram illustrating an exemplary logic circuit for implementing dynamic noise immunity and minimizing delay of complementary metal oxide semiconductor (CMOS) logic circuits in accordance with the preferred embodiment;

FIG. 5 is a block diagram illustrating a computer program product in accordance with the preferred embodiment.

### DETAILED DESCRIPTION OF THE PREFERRED EMBODIMENTS

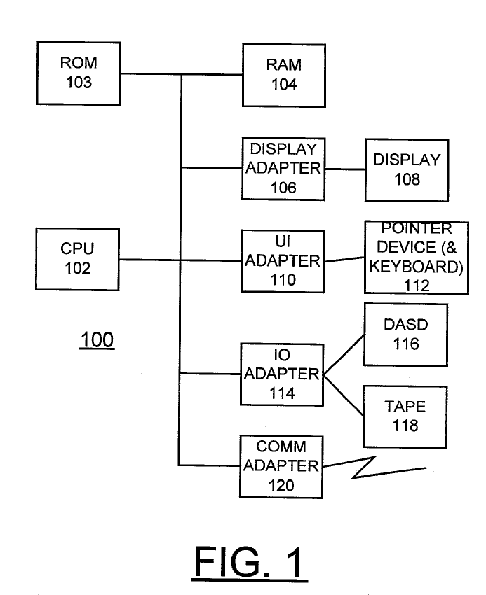

Having reference now to the drawings, in FIG. 1, there is shown a computer or data processing system of the preferred embodiment generally designated by the reference character 100. As shown in FIG. 1, computer system 100 includes a central processor unit (CPU) 102, a read only memory 103, a random access memory or main memory 104, and a display adapter 106 coupled to a display 108. CPU 102 is connected to a user interface (UI) adapter 110 connected to a pointer device and keyboard 112. CPU 102 is connected to an input/output (10) adapter 114 connected to a direct access storage device (DASD) 116 and a tape unit 118. CPU 102 is connected to a communications adapter 120 providing a communications function.

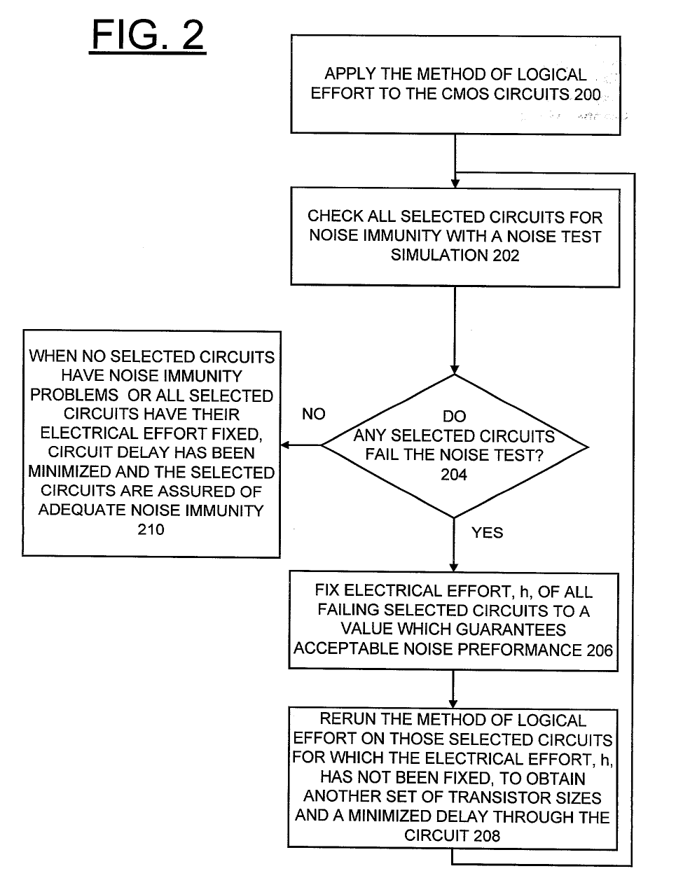

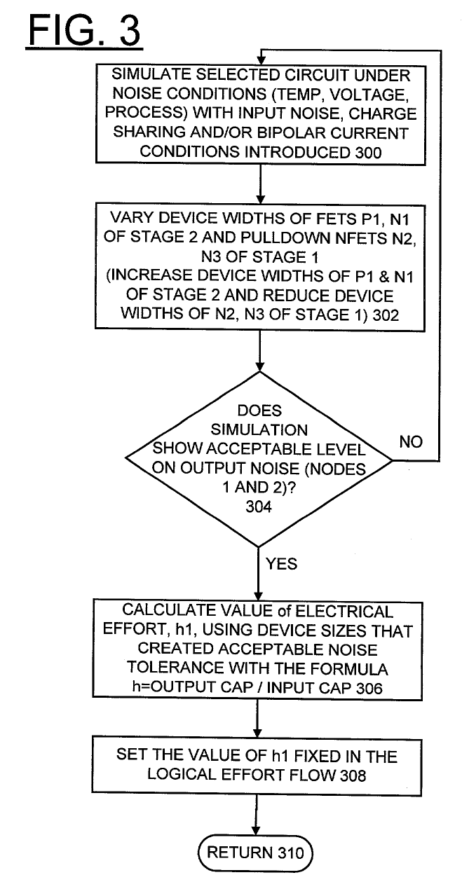

Various commercially available processors could be used for computer system 100, for example, an IBM personal computer or similar workstation can be used. An example of a specific computer system on which the invention may be implemented is the International Business Machines Corp. RS/6000 computer system. Central processor unit(s) 102 is suitably programmed to execute the flowcharts of FIGS. 2 and 3, for implementing noise immunity and minimizing delay of logical complementary metal oxide semiconductor (CMOS) circuits in accordance with the preferred embodiment.

In accordance with features of the preferred embodiment, by implementing an algorithm of the invention as illustrated in FIG. 2, dynamic noise immunity is added to the method of logical effort, that assures dynamic noise immunity as well as minimizing the delay through the circuit. The algorithm is simple and can be easily implemented in software.

Referring now to FIG. 2, there are shown sequential steps for implementing dynamic noise immunity and minimizing delay of complementary metal oxide semiconductor (CMOS) logic circuits in accordance with the preferred embodiment.

As indicated in a block 200, the method of logical effort is applied to the CMOS circuits as usual as described in the above-identified reference entitled “Logical Effort: Designing Fast CMOS Circuits”. The subject matter of chapters 1 and 3 of the above-identified reference is incorporated herein by reference. Transistor sizes are generated at block 200 for the CMOS circuits so that the delay from the input to the output of the circuit is minimized.

Using the transistors sizes generated at block 200, selected circuits including, for example, all dynamic circuits, passgate circuits, and the like, are checked for noise immunity with a noise test simulation as indicated in a block 202. Checking for any selected circuits that fail the noise test is performed as indicated in a block 204. If any of the selected circuits fail the noise test, then the electrical efforts, h, for any failing selected circuits are fixed to a value which will guarantee acceptable noise performance as indicated in a block 206. If none of the selected circuits fail the noise test, then the sequential steps go to a block 210.

After the electrical efforts, h, for any failing selected circuits are fixed at block 206, then the method of logical effort is rerun on those circuits for which the electrical effort, h, has not been fixed, to obtain another set of transistor sizes and a minimized delay through each of the circuits as indicated in a block 208.

Then the sequential steps return to block 202 so that the remaining selected circuits whose electrical effort was not fixed for noise immunity are checked again, to make sure no additional selected circuits are now experiencing a noise problem. If any of the remaining selected circuits whose electrical effort was not fixed for noise immunity fail the noise test at block 202, then the electrical efforts, h, for any failing selected circuits are fixed at block 206 and the sequential steps are repeated.

When none of the selected circuits have noise immunity problems, or all of the selected circuits have had their electrical efforts fixed, the delay through the circuit has been minimized and the selected circuits are all assured of adequate noise immunity as indicated in a block 210.

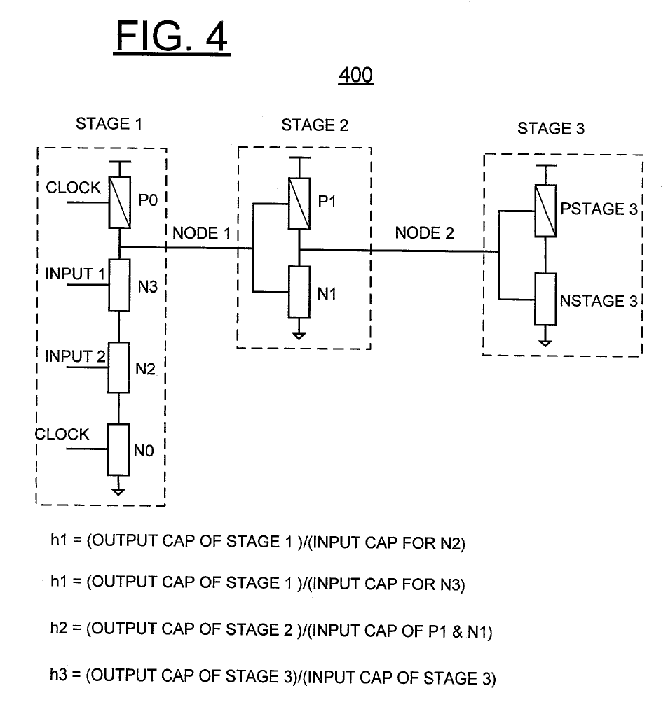

Having reference now to FIGS. 3 and 4, in FIG. 3 there are shown exemplary sequential steps for fixing the electrical efforts, h, for any failing selected circuits at block 206 of FIG. 2. FIG. 4 illustrates an exemplary logic circuit 400 for reference in the method steps of FIG. 3 for fixing noise immunity in a dynamic circuit. Logic circuit 400 includes three stages 1-3 including a stage 1 of a Domino NFET network and stages 2 and 3 of a Domino output inverter. Stage 1 includes a clocked P-channel field effect transistor (PFET) P0 and a clocked N-channel field effect transistor (NFET) N0 and pulldown NFETs N2, N3. Stage 2 includes two FETs (P1 and N1) having inputs coupled to the junction of P0 and N3 at node 1. Stage 3 includes two FETs (Pstage 3 and Nstage 3) having inputs coupled to the junction of P1 and N1 at node 2. As shown in FIG. 4, the electrical efforts of logic circuit 400 are represented as follows:

h1=(OUTPUT CAP OF STAGE 1)/(INPUT CAP for N2)

h1=(OUTPUT CAP OF STAGE 1)/(INPUT CAP for N3)

h2=(OUTPUT CAP OF STAGE 2)/(INPUT CAP OF P1 and N1)

h3=(OUTPUT CAP OF STAGE 3)/(INPUT CAP OF STAGE 3)

Referring now to FIGS. 3 and 4, first the selected circuit is simulated under noise conditions, such as temperature, voltage, process, and the like, with input noise, charge sharing and/or bipolar current introduces as indicated in a block 302. The device widths of the stage 2 FETs (P1 and N1) and the pulldown NFETs in stage 1 (N2, N3) are varied as indicated in a block 302. Typically the FETs P1 and N1 of stage 2 are increased and the pulldown NFETs N2 and N3 of stage 1 are reduced at block 302. Checking whether the simulation shows an acceptable level of output noise on node 1 and node 2 is performed as indicated in a decision block 304. If an acceptable level of output noise on node 1 and node 2 is not shown, the selected circuit is simulated again at block 300 and the device sizes are varied at block 302. The process is repeated until an acceptable level of output noise on node 1 and node 2 is shown. Then the value of h1 is calculated using the device sizes that created acceptable noise tolerance with the formula:

h=OUTPUT CAP/INPUT CAP,

where CAP represents capacitance as indicated in a block 306. Then the value of h1 is set fixed in the logical effort flow at block 206 in FIG. 2. Proof #1: A proof for the algorithm for implementing dynamic noise immunity and minimizing delay of the preferred embodiment for three stages, such as shown in FIG. 4, follows:

The delay equation for a 3 stage circuit is written as follows:

D=(g₁h₁+p₁)+(g₂h₂+p₂)+(g₃h₃+p₃)

Assume that stages 1 and 2 are the Domino NFET network and Domino output inverter, respectively, such as shown in FIG. 4. Assume noise requirements require that hi be set to a constant, h₂ and h₃ are now the only variables in the equations. Since the total electrical effort is

H=h₁h₂h₃

h₂ can be expressed as,

h₂=H/h₁h₃

Replace this value back into the delay equation,

D=(g₁h₁+p₁)+((g₂H/h₁h₃)+h)+(g₃h₃+p₃)

take the derivative with respect to h₃, and minimize,

∂D/∂h₃=(−g₂H/h₁h₃²+g₃)=0

Substitute back in the expression for H and simplify to get,

g₂h₂=g₃h₃

which proves that the delay is minimized when the stage efforts of the stages for which h₁ has not been fixed are set to be equal to each other, in the case of a three stage circuit. The delay can no longer be the best possible delay by applying the method of logical effort as is, but the delay can still be minimized. Notice that the delay of stage 1,

d₁=g₁h₁+p₁

is a constant since g₁, h₁, and p₁ are all constants, so they drop out of the minimization procedure when the derivative was taken. Notice also that the result is the same regardless of whether the Domino NFET network is stage 1, 2, or 3. A similar procedure will indicate that in order to minimize delay, the stage efforts of the stages for which h₁ has not been fixed are set to be equal to each other. If two of the stages have a fixed h₁, then we are back to the trivial non-optomizable case.

Proof #2: A proof for the algorithm for implementing dynamic noise immunity and minimizing delay of the preferred embodiment for the general case follows. The proof is readily extendible to any number of stages as follows.

Take the three stage design and add another stage in front of it called stage 0. If stage 0 is a Domino NFET network for which the electrical effort must be a constant, again, to improve the noise immunity, the solution is trivial: The delay for stage 0,

d₀=g₀h₀+p₀

is a constant.

If stage 0 does not need to have a fixed electrical effort then the proof is as follows. Let M be the total number of stages for which the electrical effort has been set to a constant. Let N be the total number of stages for which the electrical effort has not been set to a constant. So M=1 and N=2 from above. The new path effort can be expressed as,

$$F = {f}_{0} ( {f}_{p} ) N {\prod }_{j ∈ J}^{M} {f}_{j}$$

where II represents a product symbol similar to a summation E except for multiplying instead of adding, J specifies which terms to include in the product and is the set of all stage indices where the electrical effort has been set to a constant, M specifies the number of terms in the product, f₀ is the stage effort of the new stage, and fₚ is the stage effort for the N stages from the original circuit above which did not have a fixed electrical effort, and which were equalized in all stages not having a fixed electrical effort in order that the delay across that part of the circuit was minimized.

Solve the general equation for fₚ

$${f}_{p} = {( F / {f}_{o} {\prod }_{j ∈ J}^{M} {f}_{j} )}^{1 / N}$$

The delay equation for the 4 stage design is written as follows:

$$D = {N ( F / {f}_{o} {\prod }_{j ∈ J}^{M} {f}_{j} )}^{1 / N} + {f}_{o} + {\sum }_{j ∈ J}^{M} {f}_{j} + {\sum }_{i = 0}^{( N + M )} {p}_{i}$$

Now take the derivative with respect to fₒ and minimize,

$$\frac{\partial D}{\partial {f}_{0}} = {N ( F / {f}_{o} {\prod }_{j ∈ J}^{M} {f}_{j} )}^{1 / N} ( - 1 / N ) ( {f}_{o}^{( ( - 1 / N ) - 1 )} ) + 1 = 0$$

Substituting back in the expression for fₚ above, and simplifying yields,

fₒ=fₚ

so the stage effort of the new stage should be equal to the stage efforts of the stages in the original circuit which did not have a fixed electrical effort, and the delay will be minimized. Continuing this line of reasoning, the proof holds true as additional stages are added onto the front of the circuit, so N and M can have any value, the Domino NFET networks can be arranged in any pattern and the delay will be minimized when the stage efforts of those stages which do not have a fixed electrical efforts are set to be equal to each other.

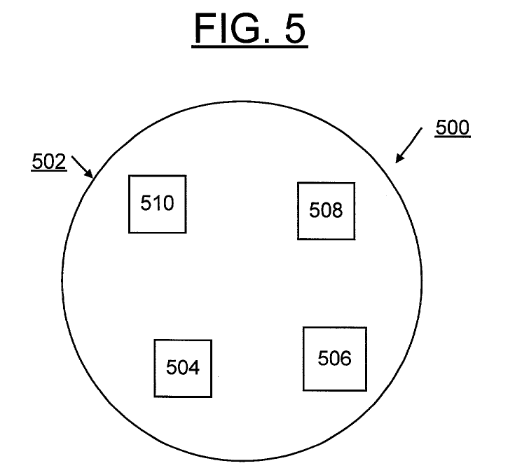

Referring now to FIG. 5, an article of manufacture or a computer program product 500 of the invention is illustrated. The computer program product 500 includes a recording medium 502, such as, a floppy disk, a high capacity read only memory in the form of an optically read compact disk or CD-ROM, a tape, a transmission type media such as a digital or analog communications link, or a similar computer program product. Recording medium 502 stores program means 504, 506, 508, 510 on the medium 502 for carrying out the methods for implementing dynamic noise immunity and minimizing delay of complementary metal oxide semiconductor (CMOS) logic circuit designs of the preferred embodiment in the system 100 of FIG. 1.

A sequence of program instructions or a logical assembly of one or more interrelated modules defined by the recorded program means 504, 506, 508, 510, direct the computer system 100 for implementing dynamic noise immunity and minimizing delay of complementary metal oxide semiconductor (CMOS) logic circuit designs of the preferred embodiment.

While the present invention has been described with reference to the details of the embodiments of the invention shown in the drawing, these details are not intended to limit the scope of the invention as claimed in the appended claims.

What is claimed is:

1. A computer implemented method for implementing noise immunity and minimizing delay of complementary metal oxide semiconductor (CMOS) logic circuits comprising the steps of:
applying a method of logical effort to the CMOS logic circuits;
checking selected circuits within said CMOS logic circuits for noise immunity utilizing a noise test simulation to identify each selected circuit failing said noise test simulation; and
modifying each identified selected circuit failing said noise test simulation for providing noise immunity.

2. A computer implemented method for implementing noise immunity and minimizing delay as recited in claim 1 wherein the step of modifying each identified selected circuit failing said noise test simulation for providing noise immunity includes the steps of fixing an electrical effort of each identified selected circuit failing said noise test simulation to a value for providing noise immunity.

3. A computer implemented method for implementing noise immunity and minimizing delay as recited in claim 2 wherein the step of fixing said electrical effort of each identified selected circuit failing said noise test simulation to said value for providing noise immunity includes the steps of varying device widths of devices within predefined stages of each identified selected circuit failing said noise test simulation.

4. A computer implemented method for implementing noise immunity and minimizing delay as recited in claim 1 wherein the step of varying device widths of devices within predefined stages of each identified selected circuit failing said noise test simulation includes the steps of reducing device widths of devices within a first stage and increasing device widths of devices within a second stage of each identified selected circuit failing said noise test simulation.

5. A computer implemented method for implementing noise immunity and minimizing delay as recited in claim 1 further includes the step of applying said method of logical effort to each remaining selected circuit not failing said noise test simulation.

6. A computer implemented method for implementing noise immunity and minimizing delay as recited in claim 5 wherein the steps of repeating said sequential steps for each remaining selected circuit not failing said noise test simulation until no selected circuit failing said noise test simulation is identified at the checking step.

7. A computer implemented method for implementing noise immunity and minimizing delay as recited in claim 1 wherein the step of applying said method of logical effort to the CMOS logic circuits includes the step of minimizing delay of the CMOS logic circuits.

8. A computer implemented method for implementing noise immunity and minimizing delay as recited in claim 1 wherein the step of checking selected circuits within said CMOS logic circuits for noise immunity utilizing said noise test simulation to identify each selected circuit failing said noise test simulation circuits includes the step of utilizing said noise test simulation to test for dynamic noise immunity of each of the selected circuits within said CMOS logic circuits.

9. Apparatus for implementing noise immunity and minimizing delay of complementary metal oxide semiconductor (CMOS) logic circuits, said apparatus including a plurality of computer executable instructions stored on a computer readable medium, wherein said instructions, when executed by said computer, cause the computer to perform the steps of:
applying a method of logical effort to the CMOS logic circuits;
checking selected circuits within said CMOS logic circuits for noise immunity to identify each selected circuit having unacceptable noise immunity; and
modifying each identified selected circuit having unacceptable noise immunity to provide acceptable noise immunity.

10. Apparatus for implementing noise immunity and minimizing delay as recited in claim 9 wherein said instructions, when executed by said computer, further cause the computer to perform the steps of applying said method of logical effort to each remaining selected circuit not having unacceptable noise immunity.

11. Apparatus for implementing noise immunity and minimizing delay as recited in claim 10 wherein said instructions, when executed by said computer, further cause the computer to perform the steps responsive to applying said method of logical effort to each remaining selected circuit not having unacceptable noise immunity of further checking said remaining selected circuit for noise immunity to identify each selected circuit having unacceptable noise immunity; and
modifying each identified selected circuit having unacceptable noise immunity to provide acceptable noise immunity.

12. Apparatus for implementing noise immunity and minimizing delay as recited in claim 9 wherein the step of checking selected circuits within said CMOS logic circuits for noise immunity to identify each selected circuit having unacceptable noise immunity includes the step of utilizing a noise test simulation for checking each of said selected circuits.

13. Apparatus for implementing noise immunity and minimizing delay as recited in claim 12 wherein the step of modifying each identified selected circuit having unacceptable noise immunity to provide acceptable noise immunity includes the step of fixing an electrical effort of each identified selected circuit failing said noise test simulation to a value for providing noise immunity.

14. A computer implemented method for implementing noise immunity and minimizing delay of complementary metal oxide semiconductor (CMOS) logic circuits comprising the steps of:
(a) applying a method of logical effort to the CMOS logic circuits;
(b) checking selected circuits within said CMOS logic circuits for noise immunity utilizing a noise test simulation to identify each selected circuit failing said noise test simulation;
(c) fixing an electrical effort of each identified selected circuit failing said noise test simulation to a value for providing noise immunity;
(d) applying said method of logical effort to each remaining selected circuit not failing said noise test simulation; and
(e) repeating said steps (b)-(d) for each remaining selected circuit not failing said noise test simulation until no selected circuit failing said noise test simulation is identified at step (b).

15. A computer implemented method for implementing noise immunity and minimizing delay as recited in claim 14 wherein the step of (c) fixing said electrical effort of each identified selected circuit failing said noise test simulation to a value for providing noise immunity includes the steps of varying device widths of devices within predefined stages of each identified selected circuit failing said noise test simulation.

16. A computer implemented method for implementing noise immunity and minimizing delay as recited in claim 15 wherein the step of varying device widths of devices within predefined stages of each identified selected circuit failing said noise test simulation includes the steps of reducing device widths of devices within a first stage and increasing device widths of devices within a second stage of each identified selected circuit failing said noise test simulation.
